(19) United States
(12) Patent Application Publication
(10) Pub. No.: US 2024/0080785 A1
(43) Pub. Date: Mar. 7, 2024

(54) METHOD AND APPARATUS FOR CONFIGURING TIMERS AND PERFORMING DATA TRANSMISSION IN A SDT PROCEDURE

(71) Applicant: Lenovo (Beijing) Limited, Beijing (CN)

(72) Inventors: Jie Shi, Beijing (CN); Lianhai Wu, Beijing (CN); Joachim Löhr, Wiesbaden (DE); Haiming Wang, Beijing (CN); Ran Yue, Beijing (CN)

(73) Assignee: Lenovo (Beijing) Limited, Beijing (CN)

(21) Appl. No.: 18/272,922

(22) PCT Filed: Jan. 25, 2021
(86) PCT No.: PCT/CN2021/073627

§ 371 Date: Jul. 18, 2023

(51) Int. Cl. H04W 56/00; H04W 76/27

(52) U.S. Cl. CPC H04W 56/0045; H04W 76/27

(57) ABSTRACT

Embodiments of the present application are directed to a method and apparatus for configuring timers and performing data transmission in a SDT procedure. In an embodiment of the present application, the method includes: receiving configured grant (CG) resource configuration information on a plurality of CG resources from a base station (BS); and determining a value of timing alignment (TA) timer based on a period of one selected CG resource from the plurality of CG resources or based on a value configured by the BS; and transmitting data in at least one of the plurality of CG resources if the TA timer is running and the at least one of the plurality of CG resources is valid.

### TECHNICAL FIELD

Embodiments of the present application generally relate to wireless communication technology, especially to a method and apparatus for configuring timers and performing data transmission in a small data transmission (SDT) procedure.

### BACKGROUND

For a user equipment (UE) in a radio resource control (RRC)_INACTIVE state (also called an inactive mode UE), it is possible to transmit uplink (UL) small data to a base station (BS) over pre-configured physical uplink shared channel (PUSCH) resources (configured grant type 1 resources), or in a random access procedure, such as, a 2-step random access channel (RACH) procedure or a 4-step RACH procedure.

Timing Advance is used to adjust the uplink (UL) frame timing relative to the downlink (DL) frame timing such that the timings of the UL frame and DL frame timing are aligned at a base bastion (BS). In narrow band-internet of things (NB-IOT), a time alignment (TA) timer is used to define the validity of the timing advance. If the TA timer is not expired and the reference signal received power (RSRP) of the UE has not changed more than a threshold, the UE will determine the timing advance is valid. In NB-IOT, the value of the TA timer is defined as N* the period of preconfigured uplink resources (PUR). The period of PUR is the period of only one PUR resource. However, for a configured grant (CG) based SDT procedure, CG could be multiple CG resources. Therefore, how to define the TA timer or how to select the CG resource for the TA timer from the multiple CG resources in a SDT procedure needs to be discussed.

### SUMMARY OF THE APPLICATION

Embodiments of the present application provide a method and apparatus for configuring timers and performing data transmission in a SDT procedure.

Some embodiments of the present application provide a method performed by a user equipment (UE). The method may include: receiving configured grant (CG) resource configuration information on a plurality of CG resources from a base station (BS); determining a value of timing alignment (TA) timer based on a period of one selected CG resource from the plurality of CG resources or based on a value configured by the BS; and transmitting data in at least one of the plurality of CG resources if the TA timer is running and the at least one of the plurality of CG resources is valid.

In an embodiment of the present application, the period of the selected CG resource is one of the following: a maximum period among periods of the plurality of CG resources; a minimum period among periods of the plurality of CG resources, an average period of periods of the plurality of CG resources; a median period base on the periods of the plurality of CG resources; a value calculated based on the periods of the plurality of CG resources; a period of a certain CG resource or a dedicated CG resource; a period of a CG resource that can be applied to all data radio bearer (DRB)(s) for small data transmission (SDT); or a period of a CG resource that can be applied to a dedicated (DRB)(s) for SDT.

In an embodiment of the present application, the value of TA timer is computed according to the period of one selected CG resource multiplied by N, wherein a value of N is suggested by the UE, and the value of N is included in a CG resource configuration request message from the UE to network.

In an embodiment of the present application, if the TA timer is expired at a time point in a duration of one CG resource among the plurality of CG resources, at least one of the following or their combination is defined for timing advance for the CG resource: timing advance is valid for the CG resource; timing advance is invalid for the CG resource; timing advance is valid if a proportion of a part of the CG resource before the time point in the duration of the CG resource is greater or not smaller than a first threshold, and/or if a proportion of a part of the CG resource after the time point in the duration of the CG resource is smaller or not greater than a second threshold; or timing advance is valid if the duration of the CG resource is smaller or not greater than a third threshold.

In an embodiment of the present application, the method may further include: starting the TA timer upon the UE moves to a radio resource control (RRC) inactive mode from a RRC connected mode, upon the UE receives a RRC release message with a suspend indication, or upon the UE receives the CG resource configuration information.

In an embodiment of the present application, the method may further include: releasing at least one of the plurality of CG resources if a number of consecutive CG resource occasions have been skipped, the number of consecutive CG resource occasions is beam specific or UE specific.

In an embodiment of the present application, the number of consecutive CG resource occasions is included in a CG resource configuration request message from the UE to the BS.

Some other embodiments of the present application provide a method performed by a user equipment (UE). The method may include at least one of the following: starting a first timer upon the UE transmits an initial data in a SDT procedure; and starting a second timer upon the UE transmits a subsequent data in the SDT procedure, wherein the first timer and the second timer are the same timer with a different value or the same value, or the first timer and second timer are different timers.

In an embodiment of the present application, a value of the first timer is a first value if a serving BS of the UE is an anchor BS of the UE, and the value of the first timer is a second value if the serving BS of the UE is not the anchor BS of the UE.

In an embodiment of the present application, a value of the first timer is associated with a data size of the initial data.

In an embodiment of the present application, a mapping of the value of the first timer and the data size is configured by a BS or predefined in the UE.

In an embodiment of the present application, the data size is associated with a buffer status report (BSR) information and/or pre-emptive BSR information.

In an embodiment of the present application, the method may further include at least one of the following or their combination: restarting the first timer upon receiving an uplink (UL) grant in a SDT procedure; restarting the first timer upon receiving a downlink (DL) assignment information for the subsequent data or upon retransmitting the initial data; restarting the first timer upon receiving a data in SDT procedure; or restarting the first timer upon transmitting a data in SDT procedure.

In an embodiment of the present application, the method may further include: stopping the first timer upon receiving a RRC response message for the initial data.

In an embodiment of the present application, the RRC response message is at least one of a RRC resume message for SDT, a RRC resume message, a RRC release message with or without a suspend indication, or a RRC reject message.

In an embodiment of the present application, a value of the second timer is associated with a data size of the subsequent data.

In an embodiment of the present application, a mapping of the value of the second timer and the data size is configured by a BS or predefined in the UE.

In an embodiment of the present application, the data size is associated with a buffer status report (BSR) information and/or pre-emptive BSR information.

In an embodiment of the present application, the method may further include at least one of the following or their combination: restarting the second timer upon transmitting another subsequent data in UE inactive mode; restarting the second timer upon receiving an uplink (UL) grant for the subsequent data; restarting the second timer upon retransmitting the subsequent data; restarting the second timer upon receiving a downlink (DL) assignment information for the subsequent data; or restarting the second timer upon receiving a DL data for the subsequent data procedure.

In an embodiment of the present application, the method may further include: stopping the second timer upon receiving an acknowledge (ACK) message for the subsequent data from a BS.

In an embodiment of the present application, the method may further include: if the second timer is expired, performs fallback to following procedure, if the corresponding procedure is available to the UE, in an order of priority of: a CG based SDT procedure; a 2-step random access channel (RACH) based SDT procedure; a 4-step RACH based SDT procedure; a 2-step RACH based procedure; and a 4-setp RACH based procedure.

In an embodiment of the present application, a packet data convergence protocol (PDCP) entity of the UE will be resumed or reestablished for SDT and non-SDT DRB before the UE transmits the initial data for SDT data, or the PDCP entity for non-SDT DRB will be re-established or resumed based on a RRC response message received by the UE.

Some other embodiments of the present application provide a method performed by a base station (BS). The method may include: transmitting configured grant (CG) resource configuration information on a plurality of CG resources to a user equipment (UE); and receiving data in at least one of the plurality of CG resources, wherein the UE determines a value of timing alignment (TA) timer based on a period of one selected CG resource from the plurality of CG resources or based on a value configured by the BS.

In an embodiment of the present application, the period of the selected CG resource is one of the following: a maximum period among periods of the plurality of CG resources; a minimum period among periods of the plurality of CG resources; an average period of periods of the plurality of CG resources; a median period base on the periods of the plurality of CG resources; a value calculated based on the periods of the plurality of CG resources, a period of a certain or a dedicated CG resource; a period of a CG resource that can be applied to all DRB(s) for small data transmission (SDT); or a period of a CG resource that can be applied to a dedicated (DRB)(s) for SDT.

In an embodiment of the present application, the method may further include: receiving a CG resource configuration request message including a value of N to the UE, wherein the value of TA timer is computed by the UE according to the period of one selected CG resource multiplied by N.

Another embodiment of the present application provides an apparatus. The apparatus may include at least one non-transitory computer-readable medium having computer executable instructions stored therein; at least one receiver; at least one transmitter; and at least one processor coupled to the at least one non-transitory computer-readable medium, the at least one receiver and the at least one transmitter.

The computer executable instructions are programmed to implement the above method with the at least one receiver, the at least one transmitter and the at least one processor.

The embodiments of the present application describe how to define the TA timer or how to select the CG resource for the TA timer from the multiple CG resources in a SDT procedure and how to perform data transmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a wireless communication system according to some embodiments of the present application;

FIG. 2 illustrates another wireless communication system according to some embodiments of the present application:

FIG. 3 illustrates a flow chart of a method for configuring a TA timer in a SDT procedure according to an embodiment of the present application:

FIG. 4 is an exemplary diagram showing the periods of the corresponding CG resources according to some embodiments of the present application:

FIG. 5 illustrates a flow chart of a method for performing data transmission in a SDT procedure according to an embodiment of the present application;

FIG. 6 illustrates an apparatus according to some embodiments of the present application; and

FIG. 7 illustrates another apparatus according to some other embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings.

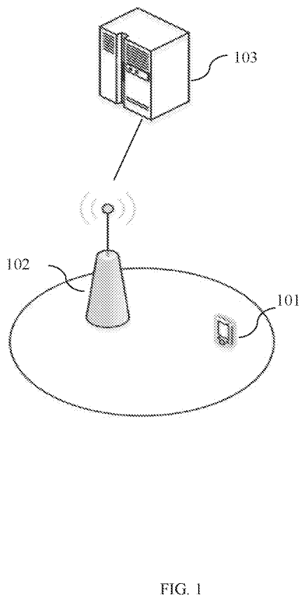

FIG. 1 illustrates a wireless communication system according to some embodiments of the present application.

As shown in FIG. 1, the wireless communication system can include at least one base station (BS) 102, at least one UE 101, and a CN node 103. Although a specific number of BSs and UEs, e.g., a BS (e.g., BS 102) and a UE (UE 101) are depicted in FIG. 1, one skilled in the art will recognize that any number of BSs and UEs may be included in the wireless communication system. As shown in FIG. 1, the BS 102 may be distributed over a geographic region and may communicate with the CN node 103 via an interface. In an example, the UE 101 could be in a RRC_IDLE state or in a RRC_INACTIVE state. When performing small data transmission, the UE 101 transmits small data to the BS 102, and the BS 102 transmits the small data to the CN node 103 via the interface.

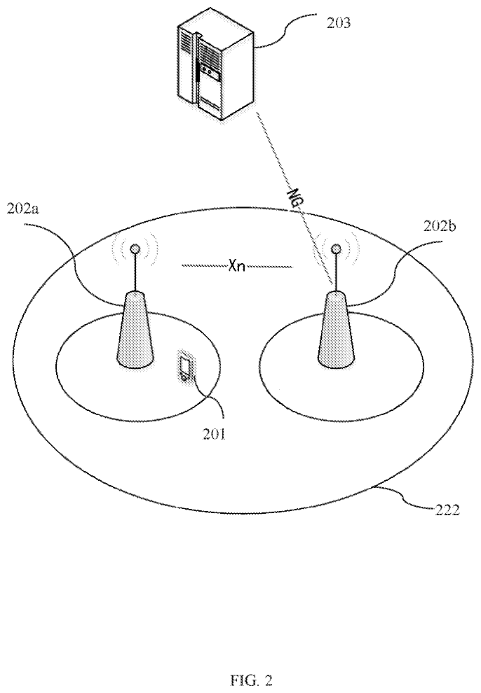

FIG. 2 illustrates another wireless communication system according to some embodiments of the present application.

As shown in FIG. 2, the wireless communication system can include at least one BS, at least one UE, and a CN node. Although a specific number of BSs and UEs, e.g., two BSs (e.g., BS 202a and BS 202b) and a UE (UE 201) are depicted in FIG. 2, one skilled in the art will recognize that any number of the BSs and UEs may be included in the wireless communication system.

The BS 202a and the BS 202b may be distributed over a geographic region, and they may communicate with each other via an interface Xn. The BS 202a and the BS 202b may communicate with a CN node 203 via an interface NG.

In some embodiments of the present application, the CN node 203 in FIG. 2 or the CN node 103 in FIG. 1 can be a mobility management entity (MME) or a serving gateway (S-GW). In some other embodiments of the present application, the CN node 203 in FIG. 2 or the CN node 103 in FIG. 1 can be a mobility management function (AMF) or a user plane function (UPF).

In some embodiments of the present application, the BS 202a or the BS 202b in FIG. 2 or the BS 102 in FIG. 1 may also be referred to as an access point, an access terminal, a base, a base unit, a macro cell, a Node-B, an evolved Node B (eNB), a gNB, a Home Node-B, a relay node, or a device, or described using other terminology used in the art. The BS 202a or the BS 202b is generally part of a radio access network that may include one or more controllers communicably coupled to one or more corresponding BS(s).

The UE 201 in FIG. 2 or the UE 101 in FIG. 1 may be a computing device, such as a desktop computer, a laptop computer, a personal digital assistant (PDA), a tablet computer, a smart television (e.g., a television connected to the Internet), a set-top box, a game console, a security system (including security cameras), a vehicle on-board computer, a network device (e.g., router, switch, and modem), or the like. According to an embodiment of the present application, the UE 201 may be a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 201 in FIG. 2 or the UE 101 in FIG. 1 may be a wearable device, such as a smart watch, a fitness band, an optical head-mounted display, or the like. Moreover, the UE 201 in FIG. 2 or the UE 101 in FIG. 1 may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system may be compatible with any type of network that is capable of sending and receiving wireless communication signals. For example, the wireless communication system can be compatible with a wireless communication network, a cellular telephone network, a time division multiple access (TDMA)-based network, a code division multiple access (CDMA)-based network, an orthogonal frequency division multiple access (OFDMA)-based network, a long term evolution (LTE) network, a 3rd generation partnership project (3GPP)-based network, a 3GPP 5G network, a satellite communications network, a high altitude platform network, and/or other communications networks.

In some embodiments of the present application, the wireless communication system can be compatible with 5G new radio of the 3GPP protocol, wherein BS 102 transmits data using an OFDM modulation scheme on the downlink (DL) and UE 101 transmits data on the uplink (UL) using a single-carrier frequency division multiple access (SC-FDMA) or OFDM scheme. More generally, however, the wireless communication system may implement some other open or proprietary communication protocols, for example, WiMAX, WiFi, among other protocols.

In some embodiments of the present application, the BS may communicate using other communication protocols, such as the IEEE 802.11 family of wireless communication protocols. Further, in some embodiments of the present application, the BS may communicate over licensed spectrums, whereas in other embodiments the BS may communicate over unlicensed spectrums. Embodiments of the present application are not intended to be limited to the implementation of any particular wireless communication system architecture or protocol. In yet some embodiments of the present application, the BS may communicate with a UE using 3GPP 5G protocols.

In an example, the UE 201 is in a RRC_INACTIVE state (or inactive mode). The BS 202a and the BS 202b are gNB. RRC_INACTIVE state is a state where a UE remains in connection management (CM)-CONNECTED and can move within an area configured by next generation-radio access network (NG-RAN) (that is, RAN notification area (RNA)) without notifying NG-RAN. As shown in FIG. 2, the UE 201 can move within the RNA 222. The BS 202b is the last serving BS of UE 201, and the UE 201 is currently in the cell covered by the BS 202a. For the UE 201 in RRC_INACTIVE, the BS 202b keeps the context of the UE 201 and the associated NG connection with the CN node 203. The BS 202b may be also referred to as “anchor BS”. The UE 201 in inactive mode may transmit uplink data. For example, the UE 201 may perform small data transmission. In an example, when performing the small data transmission, the BS 202a may transmit the data from the UE 201 to the BS 202b via the interface Xn, and then the BS 202b transmits the data to the CN node 203. In another example, when performing the small data transmission, the BS 202a knows that there is data from the UE 201 to be transmitted, the BS 202a first obtains the context of the UE 201 from the BS 202b and then transmits the data from the UE 201 to the CN node 203.

Herein, the data transmission or small data transmission (SDT) may mean that a UE in an inactive state/mode or an idle state/mode could transmit the data to the network side (or network), or receive the data from the network side. The details could be as follows:

An inactive UE may have a CN connection in a cell (e.g., cell A) associated with its last serving BS (also referred to as “anchor BS”). However, in some scenarios, the inactive UE may perform data transmission via another cell (cell B). The data transmission may include at least one of an uplink data transmission and downlink data transmission. For example, the inactive UE may initiate an uplink data transmission via cell B, establish a RAN connection with cell B, enter the connected mode, and then perform the data transmission. Or, the inactive UE may initiate an uplink data transmission via cell B and still stay in inactive mode in the data transmission procedure. An idle UE may act similarly.

After the completion of the data transmission, the inactive or idle UE may receive a suspend message or release message from cell B and then go back to the inactive or idle mode. Or, after the completion of the data transmission, the inactive or idle UE may receive a suspend message or release message from cell B and the UE still stay in inactive or idle mode in the data transmission procedure. In some embodiments of the present disclosure, the suspend message or release message can be an RRC message. In some embodiments of the present disclosure, the data size in such data transmission may be not greater than the maximum transport block (TB) size that can be applied in one transmission, as defined in standard protocols. Small data transmission is one of such scenarios.

Currently, a UE in inactive mode could perform a small data transmission over configured grant type 1 resources, Msg.A for 2-step RACH, or Msg.3 in normal RACH from INACTIVE state. And a work item description (WID) on small data transmission (SDT) in a RRC_INACTIVE state is as follows:
For the RRC_INACTIVE state:
   UL small data transmissions for RACH-based schemes (i.e. 2-step and 4-step RACH):
      General procedure to enable UP data transmission for small data packets from INACTIVE state (e.g. using MSGA or MSG.3) [RAN2]
      Enable flexible payload sizes larger than the Rel-16 CCCH message size that is possible currently for INACTIVE state for MSGA and MSG.3 to support UP data transmission in UL (actual payload size can be up to network configuration) [RAN2]
      Context fetch and data forwarding (with and without anchor relocation) in INACTIVE state for RACH-based solutions [RAN2, RAN3]
   Note 1: The security aspects of the above solutions should be checked with SA3 (Services & Systems Aspects 3)
   Transmission of UL data on pre-configured PUSCH resources (i.e. reusing the configured grant type 1)—when TA (timing advance) is valid
      General procedure for small data transmission over configured grant type 1 resources from INACTIVE state [RAN2]
      Configuration of the configured grant type1 resources for small data transmission in UL for INACTIVE state [RAN2]
No new RRC state should be introduced in this WID. Transmission of small data in UL, subsequent transmission of small data in UL and DL and the state transition decisions should be under network control. Focus of the WID should be on licensed carriers and the solutions can be reused for NR-U if applicable.
Note 2: Any associated specification work in RAN1 that is needed to support the above set of objectives should be initiated by RAN2 via an LS.

As discussed above, in NB-IOT, a TA timer is used to define the validity of timing advance. If the TA timer is not expired and the RSRP of the UE has not changed more than a threshold, the UE will determine the timing advance is valid. In NB-IOT, the value of the TA timer is defined as N* the period of PUR. The period of PUR is the period of only one PUR resource. However, for the CG based SDT procedure, CG could be multiple CG resources. Therefore, how to define the TA timer or how to select the CG resource for the TA timer from the multiple CG resources in the SDT procedure needs to be discussed.

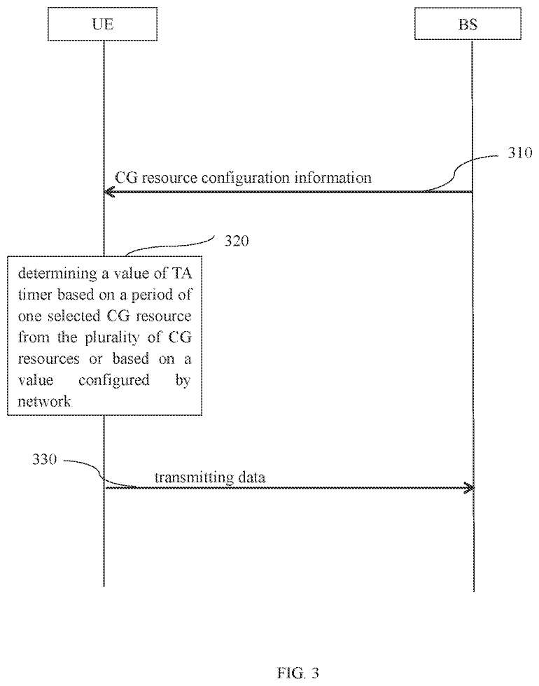

FIG. 3 illustrates a flow chart of a method for configuring a TA timer in a SDT procedure according to an embodiment of the present application. In this embodiment, the method is performed between a UE and a BS.

As shown in FIG. 3, in operation 310, the BS may transmit CG resource configuration information to the UE. The CG resource configuration information includes the information on a plurality of CG resources.

After receiving the CG resource configuration information from the BS, in operation 320, the UE may determine a value of TA timer based on a period of one selected CG resource from the plurality of CG resources.

The CG resource could be beam-specific and/or traffic specific. Beam-specific CG resource means the beam information of each CG resource is different. The traffic specific CG resource means that the period of each CG resource is different.

In another embodiment, for example, in the case that there is only one CG resource, the UE may determine the value of TA timer based on a value configured by network (the BS). For example, the network may configure a value associated with the TA timer, so that the UE may determine the value of TA timer based on the value configured by the network. The configured value may be one or several milliseconds.

The determining of the value of TA timer based on the period of one selected CG resource from the plurality of CG resources will be described in detail in the following embodiments.

In an embodiment of the present application, the period of the selected CG resource may be a maximum period (beam period) among periods of the plurality of CG resources.

In another embodiment of the present application, the period of the selected CG resource may be a minimum period (beam period) among periods of the plurality of CG resources.

In another embodiment of the present application, the period of the selected CG resource may be an average period of periods of the plurality of CG resources.

In another embodiment of the present application, the period of the selected CG resource may be a median period base on the periods of the plurality of CG resources.

In another embodiment of the present application, the period of the selected CG resource may be a value calculated based on the periods of the plurality of CG resources. For example, the value may be calculated based on a function with respect to the periods of the plurality of CG resources.

In the above embodiments, the CG resources could be at least one type of the CG resource that is applied to all data radio bearer (DRB)(s) for SDT, or the CG resource that is applied to a dedicated DRB(s) for SDT. The CG resource could be beam specific CG resource, or a CG resource related to multiple beams, or the UE specific CG resource.

In another embodiment of the present application, the period of the selected CG resource may be a period of a certain CG resource (such as, the first CG resource) or a dedicated CG resource. The dedicated CG resource may be configured by network (the BS).

In another embodiment of the present application, the period of the selected CG resource may be a period of a CG resource (such as, the first CG resource) that can be applied to all data radio bearer (DRB)(s) for SDT. The CG resource may be DRB-specific.

In another embodiment of the present application, the period of the selected CG resource may be a period of a CG resource that can be applied to a dedicated (DRB)(s) for SDT.

The UE may compute the value of TA timer according to the period of one selected CG resource multiplied by N. N may be beam specific or UE specific. The value of N may be suggested by the UE, and the value of N is included in a CG resource configuration request message from the UE to network. In another example, the value of N may be predefined.

The UE may start the TA timer upon the UE moves to a radio resource control (RRC) inactive mode from a RRC connected mode, upon the UE receives a RRC release message with a suspend indication, or upon the UE receives the CG resource configuration information.

If the TA timer is expired at a time point in a duration of one CG resource among the plurality of CG resources, one of the following or their combination may be defined for timing advance for the CG resource:

In an embodiment, timing advance is valid for the CG resource.

In another embodiment, timing advance is invalid for the CG resource.

In another embodiment, timing advance is valid if a proportion of a part of the CG resource before the time point in the duration of the CG resource is greater (larger) than a first threshold (such as, threshold A), and/or if a proportion of a part of the CG resource after the time point in the duration of the CG resource is smaller or not greater than a second threshold (such as, threshold B).

In another embodiment, timing advance is invalid if a proportion of a part of the CG resource before the time point in the duration of the CG resource is smaller or not greater (larger) than a third threshold (such as, threshold C), and/or if a proportion of a part of the CG resource after the time point in the duration of the CG resource is greater (larger) or not smaller than a fourth threshold (such as, threshold D).

In another embodiment, timing advance is valid if the duration of the CG resource is smaller or not greater (larger) than a fifth threshold (such as, threshold E).

In another embodiment, timing advance is valid if the duration of the CG resource is greater (larger) or not smaller than a sixth threshold (such as, threshold F).

In another embodiment, timing advance is invalid if the duration of the CG resource is not smaller or greater (larger) than a seventh threshold (such as, threshold G).

In the above embodiments, the thresholds could be configured to the UE from the network (the BS) or predefined or stored in the UE.

In operation 330, the UE may transmit data in at least one of the plurality of CG resources if the TA timer is running and the at least one of the plurality of CG resources is valid. It should be understood that “the TA timer is running” and “the at least one of the plurality of CG resources is valid” can be two conditions of transmitting of the data in at least one of the plurality of CG resources, and other conditions may be further involved.

Furthermore, if a number of consecutive CG resource occasions have been skipped (for example, since the timing advance is invalid), the plurality of CG resources could be released by the UE. The number of consecutive CG resource occasions is beam specific or UE specific.

For example, if the number of consecutive CG occasions associated with a beam (such as, beam A) is skipped, the CG resource(s) associated with the beam (such as, beam A) will be released. If the number of consecutive CG occasions associated with a beam (such as, beam A) and/or other beam which is related to one CG resource is skipped, the CG resource will be released.

The number of consecutive CG resource occasions may be included in the CG resource configuration request message from the UE to the BS. That is, the number of consecutive CG resource occasions may be suggested by the UE. In another embodiment, the number of consecutive CG resource occasions may be predefined in the UE.

Furthermore, the number of consecutive CG resource occasions could be configured by the network. For example, the BS may transmit the number of consecutive CG resource occasions in the CG resource configuration information to the UE.

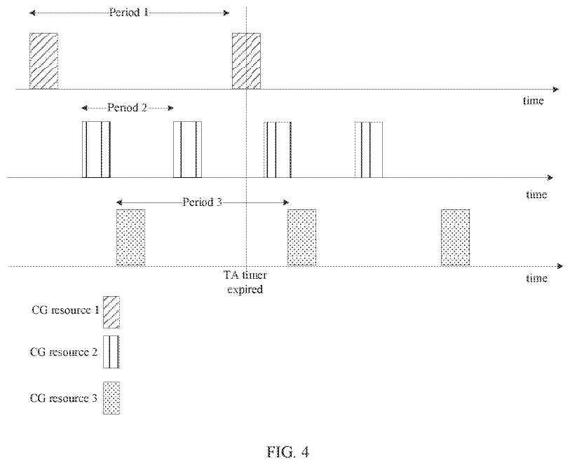

FIG. 4 is an exemplary diagram showing the periods of the corresponding CG resources according to some embodiments of the present application.

As shown in FIG. 4, it shows the period of CG resource 1 (period 1), and period of CG resource 2 (period 2), and the period of CG resource 3 (period 3).

According to the above description, the UE may determine the value of the TA timer based on the period of one selected CG resource.

Furthermore, FIG. 4 shows that the TA timer is expired at a time point in the duration of CG resource 1. Thus, it can be determined whether timing advance is valid for the CG resource 1 according to the above described embodiments.

In a SDT procedure, initial data transmission and subsequent data transmission may be performed. Generally, a timer for initial transmission and subsequent transmission could be predefined, and the timer may be related to the data size in SDT procedure.

In some embodiments of the present application, in a SDT procedure, a first timer (such as, timer A) may be introduced for transmitting an initial data, and a second timer (such as, timer B) may be introduced for transmitting the subsequent data. In some embodiments of the present application, in a SDT procedure, a first timer (such as, timer A) may be introduced for transmitting an initial data, and the first timer (such as, timer A) can also be utilized for transmitting the subsequent data.

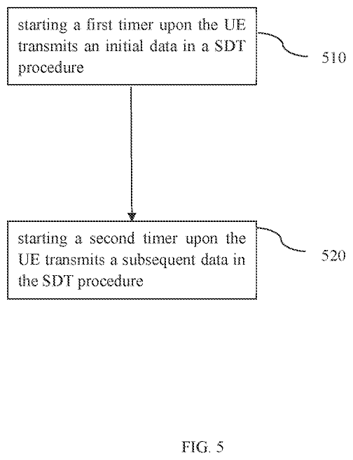

FIG. 5 illustrates a flow chart of a method for performing data transmission in a SDT procedure according to an embodiment of the present application. In this embodiment, the method is performed by a UE.

As shown in FIG. 5, in operation 510, the UE starts a first timer (such as, timer A) upon the UE transmits an initial data in a SDT procedure.

In operation 520, the UE starts a second timer (such as, timer B) upon the UE transmits a subsequent data in the SDT procedure.

In some embodiments, the first timer (such as, timer A) and the second timer (such as, timer B) may be the same timer with a different value or the same value. In some other embodiments, the first timer and second timer are different timers. The first timer and second timer may have different value. In an example, the value of the first timer for transmitting the initial data may be greater than the value of the second timer for transmitting the subsequent data in consideration of the initial transmission in the SDT procedure may take more time than the subsequent data transmission.

As discussed in the above, the first timer (such as, timer A) is used in the initial transmission in SDT procedure, and it could be longer and similar to the timer T319. The value of the first timer could be defined in system information block (SIB), a RRC release message for the UE, or predefined in the UE.

In an embodiment, the value of the first timer may depend on whether the serving BS of the UE is the anchor BS where the UE context is stored. For example, the value of the first timer may be a first value if a serving BS of the UE is an anchor BS of the UE, and the value of the first timer is a second value if the serving BS of the UE is not the anchor BS of the UE. The UE may know its anchor BS based on its inactive-radio network temporary identifier (I-RNTI) information in UE inactive mode. For example, the first value may be smaller than the second value.

In another embodiment, the value of the first timer can be associated with a data size of the initial data. The mapping of the value of the first timer and the data size may be configured by a BS or predefined in the UE. The data size is associated with a buffer status report (BSR) information and/or pre-emptive BSR information. The value of the first timer may be synchronized between the BS and the UE based on the BSR information or pre-emptive BSR information.

In yet another embodiment, the value of the first timer may depend on both whether the serving BS of the UE is an anchor BS of the UE and the data size of the initial data.

Furthermore, the UE may restart the first timer in at least one of the following cases or their combination.

In an example, the UE may restart the first timer upon receiving an uplink (UL) grant in a SDT procedure.

In another example, the UE may restart the first timer upon receiving a downlink (DL) assignment information for the subsequent data or upon retransmitting the initial data.

In another example, the UE may restart the first timer upon receiving a data in SDT procedure.

In another example, the UE may restart the first timer upon transmitting a data in SDT procedure.

Furthermore, the UE may stop the first timer upon receiving a RRC response message for the initial data. For example, the RRC response message can be at least one of a RRC resume message for SDT, a RRC resume message, a RRC release message with or without a suspend indication, or a RRC reject message.

If the first timer is expired, the UE fails to initiate the SDT procedure.

As discussed in the above, the second timer (such as, timer B) is used in subsequent transmission in a SDT procedure, or the first timer (such as, timer A) with a different value is restarted in the subsequent transmission.

The following description is for the second timer, and it should be understood that these descriptions should also apply to the first timer which is restarted in the subsequent transmission.

The value of the second timer could be defined in SIB or a RRC release message for the UE, or predefined in the UE.

In an embodiment, the value of the second timer can be associated with the data size of the subsequent data. The mapping of the value of the second timer and the data size may be configured by the BS or predefined in the UE. The data size can be associated with a BSR information and/or pre-emptive BSR information. The value of the second timer may be synchronized between the BS and the UE based on the BSR information and/or pre-emptive BSR information.

Furthermore, the UE may restart the first timer in at least one of the following cases or their combination.

In an example, the UE may restart the second timer upon transmitting another subsequent data in UE inactive mode.

In another example, the UE may restart the second timer upon receiving an UL grant for the subsequent data.

In another example, the UE may restart the second timer upon retransmitting the subsequent data.

In another example, the UE may restart the second timer upon receiving a DL assignment information for the subsequent data.

In another example, the UE may restart the second timer upon receiving a DL data for the subsequent data procedure.

Furthermore, the UE may stop the second timer upon receiving a RRC response message for the subsequent data transmission from a BS. The RRC response message is at least one of a RRC resume message for SDT, a RRC resume message, a RRC release message with or without a suspend indication, or a RRC reject message.

For example, the UE may stop the second timer upon receiving an acknowledge (ACK) message for the subsequent data from a BS.

If the second timer is expired, the UE fails to initiate the SDT procedure. The UE will perform fallback to following procedure, if the corresponding procedure is available to the UE, in an order of priority of: a CG based SDT procedure, a 2-step RACH based SDT procedure, a 4-step RACH based SDT procedure, a 2-step RACH based procedure, and a 4-setp RACH based procedure. Or, the corresponding procedure is available to the UE, in an order of priority of: a SDT based procedure, a non-SDT based procedure. For example, only if the CG based SDT procedure is available to the UE, the CG based SDT procedure will be selected. Otherwise, the 2-step RACH based SDT procedure with the second highest priority will be selected, and so on. The UE could perform the fallback from the procedure where it is in to the next procedure in the following procedure with the order of priority. For example, if the second timer is expired in the 2-step RACH based SDT procedure, the UE shall perform the 4-step RACH based SDT procedure.

Furthermore, a packet data convergence protocol (PDCP) entity of the UE will be resumed or reestablished for SDT and non-SDT DRB before the UE transmits the initial data for SDT data. Furthermore, a radio link control (RLC) entity will not be configured or re-established before the UE transmits the initial data for SDT data.

In another embodiment, the PDCP entity for non-SDT DRB will be re-established or resumed based on the RRC response message received by the UE.

The RRC response message could be the response message to a RRC resume request (RRCResumeRequest) message for the initial data for SDT. The RRC response message could keep the UE continuing the subsequent data transmission in UE inactive mode. The RRC response message could configure the UE to reestablish the PDCP entity for non-SDT DRB and/or configure the UE not to re-establish the RLC entity for non-SDT DRB.

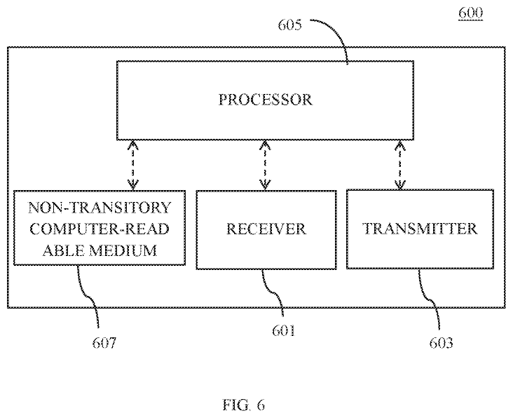

FIG. 6 illustrates an apparatus according to some embodiments of the present application. In some embodiments of the present disclosure, the apparatus 600 may be the UE 101 as illustrated in FIG. 1, the UE 201 as illustrated in FIG. 2 or other embodiments of the present application.

As shown in FIG. 6, the apparatus 600 may include a receiver 601, a transmitter 603, a processer 605, and a non-transitory computer-readable medium 607. The non-transitory computer-readable medium 607 has computer executable instructions stored therein. The processer 605 is configured to be coupled to the non-transitory computer readable medium 607, the receiver 601, and the transmitter 603. It can be contemplated that, in some other embodiments of the present application, the apparatus 600 may include more computer-readable mediums, receiver, transmitter and processors according to practical requirements. In some embodiments of the present application, the receiver 601 and the transmitter 603 can be integrated into a single device, such as a transceiver. In certain embodiments, the apparatus 600 may further include an input device, a memory, and/or other components.

In some embodiments of the present application, the non-transitory computer-readable medium 607 may have stored thereon computer-executable instructions to cause the processer 605 to implement the method according to embodiments of the present application.

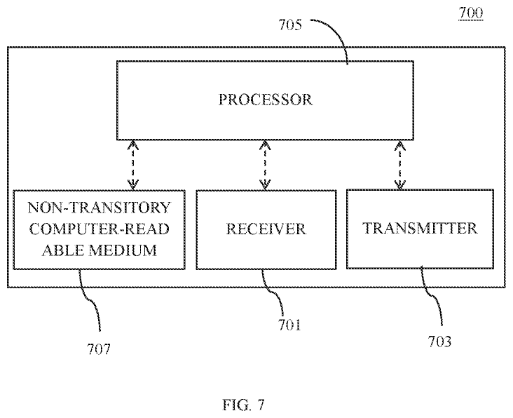

FIG. 7 illustrates another apparatus according to some embodiments of the present application. In some embodiments of the present disclosure, the apparatus 700 may be the BS 102 as illustrated in FIG. 1, the BS 202a or BS 202b as illustrated in FIG. 2 or other embodiments of the present application.

As shown in FIG. 7, the apparatus 700 may include a receiver 701, a transmitter 703, a processer 705, and a non-transitory computer-readable medium 707. The non-transitory computer-readable medium 707 has computer executable instructions stored therein. The processer 705 is configured to be coupled to the non-transitory computer readable medium 707, the receiver 701, and the transmitter 703. It can be contemplated that, in some other embodiments of the present application, the apparatus 700 may include more computer-readable mediums, receiver, transmitter and processors according to practical requirements. In some embodiments of the present application, the receiver 701 and the transmitter 703 are integrated into a single device, such as a transceiver. In certain embodiments, the apparatus 700 may further include an input device, a memory, and/or other components.

In some embodiments of the present application, the non-transitory computer-readable medium 707 may have stored thereon computer-executable instructions to cause a processor to implement the method according to embodiments of the present application.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory. EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. An apparatus, comprising:
a receiver;
a transmitter; and
a processor coupled to the receiver and the transmitter configured to cause the apparatus to:
receive configured grant (CG) resource configuration information on a plurality of CG resources from a base station (BS);
determine a value of a timing alignment (TA) timer based on a period of one selected CG resource from the plurality of CG resources or based on a value configured by the BS; and
transmit data in at least one of the plurality of CG resources if the TA timer is running and the at least one of the plurality of CG resources is valid.

2. The apparatus of claim 1, wherein the period of the selected CG resource is one of:
a maximum period among periods of the plurality of CG resources;
a minimum period among periods of the plurality of CG resources;
an average period of periods of the plurality of CG resources;
a median period base on the periods of the plurality of CG resources;
a value calculated based on the periods of the plurality of CG resources;
a period of a certain CG resource or a dedicated CG resource;
a period of a CG resource that can be applied to all data radio bearers (DRBs) for small data transmission (SDT); or
a period of a CG resource that can be applied to a dedicated one or more DRBs for SDT.

3. The apparatus of claim 1, wherein a value of the TA timer is computed according to the period of one selected CG resource multiplied by N,
wherein a value of N is suggested by the apparatus, and the value of N is included in a CG resource configuration request message from the apparatus to a network.

4. The apparatus of claim 1, wherein if the TA timer is expired at a time point in a duration of one CG resource among the plurality of CG resources, a timing advance for the CG resource is defined as one or more of:
the timing advance is valid for the CG resource;
the timing advance is invalid for the CG resource;
the timing advance is valid if a proportion of a part of the CG resource before the time point in the duration of the CG resource is greater or not smaller than a first threshold, or if a proportion of a part of the CG resource after the time point in the duration of the CG resource is smaller or not greater than a second threshold; or
the timing advance is valid if the duration of the CG resource is smaller or not greater than a third threshold.

5. The apparatus of claim 1, wherein the processor is configured to cause the apparatus to: start the TA timer upon the apparatus moving to a radio resource control (RRC) inactive mode from a RRC connected mode, upon the apparatus receiving a RRC release message with a suspend indication, or upon the apparatus receiving the CG resource configuration information.

6. The apparatus of claim 1, wherein the processor is configured to cause the apparatus to: release at least one of the plurality of CG resources if a number of consecutive CG resource occasions have been skipped, wherein the number of consecutive CG resource occasions is beam specific or apparatus specific.

7. The apparatus of claim 6, wherein the number of consecutive CG resource occasions is included in a CG resource configuration request message from the apparatus to the BS.

8. A method performed by a user equipment (UE), comprising at least one of:
starting a first timer upon the UE transmitting an initial data in a small data transmission (SDT) procedure; and
starting a second timer upon the UE transmitting a subsequent data in the SDT procedure,
the first timer and the second timer being a same timer with a different value or a same value, or the first timer and second timer being different timers.

9. The method of claim 8, wherein a value of the first timer is a first value if a serving base station (BS) of the UE is an anchor BS of the UE, and the value of the first timer is a second value if the serving BS of the UE is not the anchor BS of the UE.

10. The method of claim 8, wherein a value of the first timer is associated with a data size of the initial data.

11. The method of claim 8, further comprising at least one:
restarting the first timer upon receiving an uplink (UL) grant in the SDT procedure;
restarting the first timer upon receiving a downlink (DL) assignment information for the subsequent data or upon retransmitting the initial data;
restarting the first timer upon receiving data in the SDT procedure; or
restarting the first timer upon transmitting data in the SDT procedure.

12. The method of claim 11, further comprising:
stopping the first timer upon receiving a radio resource control (RRC) response message for the initial data.

13. The method of claim 8, further comprising at least one of:
restarting the second timer upon transmitting another subsequent data in UE inactive mode;
restarting the second timer upon receiving an uplink (UL) grant for the subsequent data;
restarting the second timer upon retransmitting the subsequent data;
restarting the second timer upon receiving a downlink (DL) assignment information for the subsequent data; or
restarting the second timer upon receiving a DL data for the subsequent data procedure.

14. The method of claim 8, further comprising:
stopping the second timer upon receiving an acknowledge (ACK) message for the subsequent data from a base station (BS).

15. The method of claim 8, wherein a packet data convergence protocol (PDCP) entity of the UE is resumed or reestablished for SDT and non-SDT data radio bearer (DRB) before the UE transmits the initial data for SDT data, or the PDCP entity for non-SDT DRB is re-established or resumed based on a radio resource control (RRC response message received by the UE.

16. An apparatus, comprising:
a receiver;
a transmitter; and
a processor coupled to the receiver and the transmitter configured to cause the apparatus to:
transmit configured grant (CG) resource configuration information on a plurality of CG resources to a user equipment (UE); and
receive data in at least one of the plurality of CG resources, the UE having determined a value of a timing alignment (TA) timer based on a period of one selected CG resource from the plurality of CG resources or based on a value configured by the apparatus.

17. The apparatus of claim 16, wherein the period of the selected CG resource is one of:
a maximum period among periods of the plurality of CG resources;
a minimum period among periods of the plurality of CG resources;
an average period of periods of the plurality of CG resources;
a median period base on the periods of the plurality of CG resources;
a value calculated based on the periods of the plurality of CG resources;
a period of a certain or a dedicated CG resource;
a period of a CG resource that can be applied to all data radio bearers (DRBs) for small data transmission (SDT); or
a period of a CG resource that can be applied to a dedicated one or more DRBs for SDT.

18. The apparatus of claim 16, wherein the processor is configured to cause the apparatus to:
receive, from the UE, a CG resource configuration request message including a value of N, a value of the TA timer having been computed by the UE according to the period of one selected CG resource multiplied by N.
